(19) United States
(12) Patent Application Publication
(10) Pub. No.: US 2011/0174167 A1
(43) Pub. Date: Jul. 21, 2011

(54) APPARATUS FOR SHAPING FOOD INTO A CYLINDRICAL ROLL

(76) Inventor: Gerhard Arnold, Wiesbaden (DE)

(21) Appl. No.: 12/992,829

(22) PCT Filed: May 7, 2009
(86) PCT No.: PCT/EP2009/003266

§ 371 Date: Jan. 19, 2011

(30) Foreign Application Priority Data
May 16, 2008 (DE) 10 2008 023 973.9

(51) Int. Cl. A23P 1/00

(52) U.S. Cl. 99/485

(57) ABSTRACT

Disclosed is an apparatus for shaping food into a cylindrical roll, comprising a flexible band that has an internal side on which the food to be shaped can be placed. In order to be able to reliably and reproducibly shape the food, said apparatus is designed such that a frame is provided to which one end of the band can be or is attached in such a way that the internal side of the free end of the band can be placed on the external side of the attachable or attached end of the band in order to form a tube.

### CROSS-REFERENCE TO RELATED APPLICATIONS

The present application claims priority to International Application No. PCT/EP2009/003266 filed on May 7, 2009, which claims priority to German Patent Application No. 102008023973.9 filed on May 16, 2008.

### STATEMENT RE: FEDERALLY SPONSORED RESEARCH/DEVELOPMENT

Not Applicable

### BACKGROUND

The invention provides an apparatus for molding food into a cylindrical roller with a flexible band having an inner side to which the food material to be shaped can be placed.

Such devices include a sushi-roller that will allow inexperienced home chefs to prepare sushi. These devices may also be used to make sausage rolls and the like. In known devices, a tape is first laid flat on a flat surface and then rice or minced meat that is to be formed is disposed thereon. Then, one end of the strip is drawn parallel to the floor around the food to form the role. In fact, a rolling motion is not necessarily performed; rather, the mass is often simply pushed in front of the band, without rolling the formation. For example, U.S. Pat. No. 5,009,905 discloses a device in which the band is formed of a bamboo mat. DE 44 09 511 discloses a similar device which forms rolls with a flexible plate. The invention is thus based on the task of developing a device of the type mentioned above in such a way that forms clean molded food rolls.

The problem described above is solved by an apparatus for molding food, which is characterized by a structure including a tape having a fixed end and a free end, wherein the inside of the free end of the tape may be disposed adjacent the outside of the fixed end to form a tube.

According to an aspect of the present invention, it was recognized that the principle of rolling is not sufficient to solve the task. On the contrary it has been shown that you move away from this principle in order to reproducibly reach satisfactory results.

Accordingly, in one particular embodiment of the device of the present invention, it is provided that the cross-section of the tube is formed by pulling on the free end of the tape—preferably in the tangential direction.

In particular, it can be provided such that the food to be shaped generally does not roll on the inside of the band. It is advantageous if the strip is manufactured from smooth material, such as Teflon or silicone, and/or has a smooth coating.

In a particular embodiment, the frame has two parallel walls, which carry the tape. The frame may be advantageously configured such that the distance between the walls is the width of the belt and/or that the band—particularly during of reducing cross-section of the tube.

In an advantageous and compact design, the frame provides a surface to which the tape can be placed. In particular, to provide certain pre-shaping, the food may reach the bottom in the direction transverse to the walls and straight in the direction parallel to the wall, in particular the shape of a circular section or pipe section.

In a particularly reliable embodiment, it is provided that the frame has at least one guide means including a dressing that defines the free end of the strip. For example, the guide means may be arranged on the walls or may be part of the walls.

In a particular design, the free end of the tape or a user definable set web can be manufactured in one piece in an advantageous way.

To ensure a particularly reliable formation of the food, the bar in the down state is a bridge between the walls. For example, the upper edge of the walls may each include a recess into which the lateral ends of the web applications fits.

To prevent part of the material to be shaped from coming out of the tube when the tube is closed, i.e., during the forming process, one embodiment includes a definable end of the strip that is formed as a sharp scraping edge or the web may include a sharp stripping structure. This ensures that the parts of the food glide past the free end of the strip at the intersection of free and fixed end “seam” of the tube.

Additionally or alternatively, there may also be provided in an advantageous manner, that in the area of the definable end or fixed end of the strip to the free end of the strip, an aligned abutment edge is provided, and/or the bridge has a free end of the tape from-facing stop edge.

To ensure good contact between the opposed ends of the tube, a crossbar can be provided with the free end of the strip pressed on the fixed end of the strip. In particular, it can be provided that the cross bar is pivotally mounted.

For example, the cross bar may be pivotally attached to a wall mounted lever. In a particularly robust design, the cross bar may be coupled to two pivotal levers mounted to the walls.

To make it easy to pinch and to minimize friction to provide an easy-to-use embodiment of the invention, the cross bars are mounted to rotate about their longitudinal central axis. The cross bar may alternatively include a pipe rotatably mounted about its central longitudinal axis. This ensures that the cross bar and the tube can roll on tape.

To achieve a safe operation the free end of the strip includes a handle. The handle and the tape can be manufactured in one piece. In particular, the handle may be releasably connected to the cross bar or the handle may be hooked on the cross bar to provide a comfortable operation. An advantageous design is such that the device consists of a frame with two parallel walls, which are connected to one another by a base, and between the walls and arranged perpendicular thereto is a band whose width is the distance between the walls. The band is fixed or is fixable to a bridge connected to both walls. Furthermore, the band consists of a flexible material, such that the end portion is placed over the web that connects to the other end so that the band forms a tube. Furthermore, the said other end of the strip is provided with a handle. In contrast to the previously known devices, the band defines a tube whose end faces can be covered by the walls. To shape the roll, the end portion is placed over the bridge and the handle is pulled tightly so that the band tightens to form the tube until the cross-section of the tube is equal the volume of the introduced mass. Since the cross section of the tube is closed, the mass does not yield. To set the bridge, the upper edge of the walls each include a recess into which fits the lateral ends of the web, preferably releasably. Essentially, the web can be fixed on the walls, but this makes it difficult to feed the device with the material to be shaped.

Thus, as the band is closed, the mass on the inside of the tape roll does not accumulate. One end of the strip possesses a sharp scraping edge.

In order to achieve a certain pre-forming, it is provided that the soil in the direction perpendicular to the walls and just goes in the direction parallel to the walls has the shape of a circle segment. The concept of circular section is representative for any kind of an arc-shaped curve, such as an oval. To distribute the weight on the band, the invention provides that the base is closed.

Thus, the end portion of the tape can be pulled tightly across the bridge. The device has an element with which the said end portion of the tape on the specified web is pressed to the walls. Preferably, the crossbar includes a lever pivotally mounted to at one of the walls.

For uniform application of force, the cross bar is connected to two pivotally mounted levers that are pivotable about a common axis. The cross bar and levers thus form a hanger.

Preferably, the handle end of the tape is provided with a hook-bar.

In order to exert a pulling force on the tape, there may be included a reinforced handle running perpendicular from the belt protruding handles.

Below is an embodiment of the invention as will be explained in more detail.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1a shows a longitudinal section view through an embodiment of an apparatus for shaping food into a cylindrical roll;

FIG. 1b shows a plan view of the representation depicted in FIG. 1a;

FIGS. 2a, 2b to 4a, 4b respectively depict in longitudinal section view and top view of the progress in the formation of food rolls; and

FIG. 5 is a detailed view of an embodiment of the definable end of the band.

### DETAILED DESCRIPTION

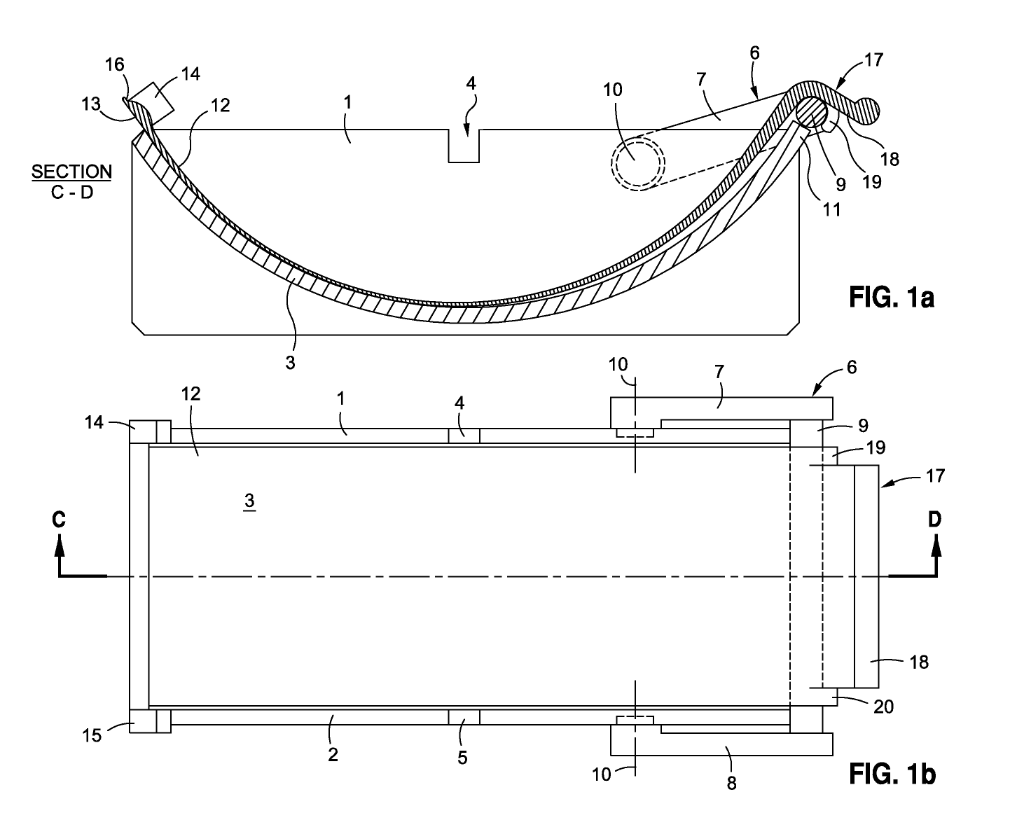

It is first made reference to the embodiments illustrated in FIGS. 1a and 1b. The device of the invention consists of two parallel walls or cheeks 1, 2, between which is an arcuate base 3 forming a closed bottom. The side edges of the arcuate base 3 are bonded or screwed to the cheeks 1, 2. The opposed ends of the arcuate base 3 terminate adjacent the upper edges of the cheeks 1, 2, so that a pan is formed with the cheeks 1, 2, defining vertical side walls. In the exemplary embodiment shown in FIGS. 1a and 1b, the arc 3 extends in a longitudinal direction parallel to the side walls and any point extending transversely to the side walls is straight.

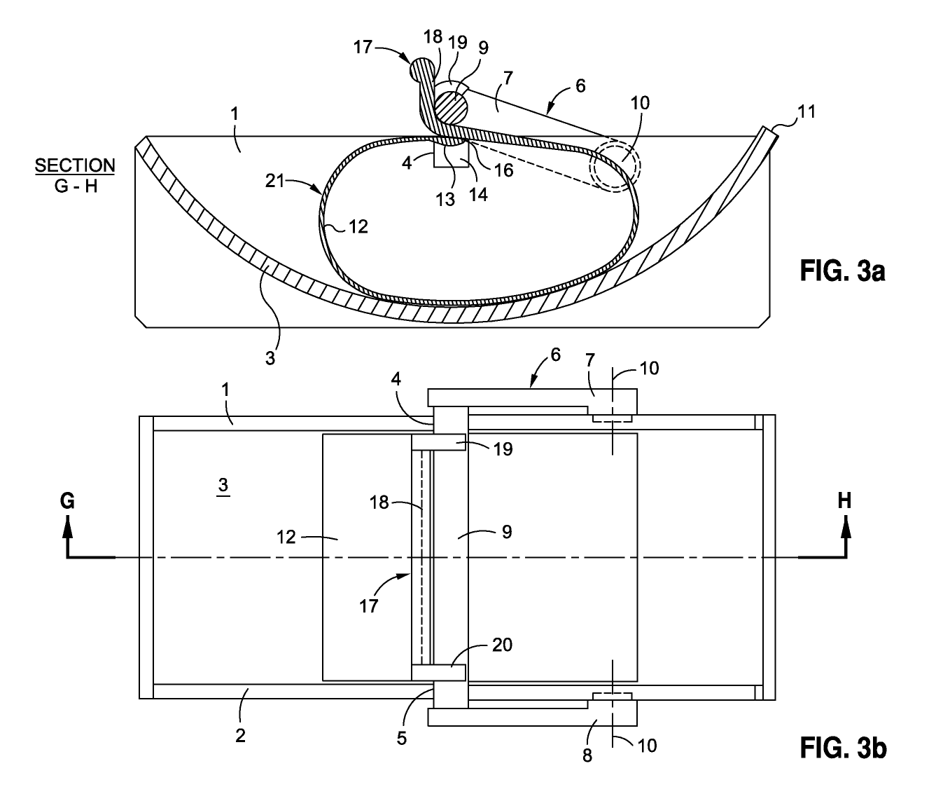

square recess 4, 5 is located in the upper edges of the cheeks 1, 2. In a preferred embodiment, the square recess 4, 5 is centrally located in the cheeks 1, 2. Furthermore, a bracket 6 is provided consisting of two levers 7, 8 connected by cross rod 9. The levers 7, 8 are located on the outer sides of the cheeks 1, 2 and pivot about a common axis 10. The axis 10 is centered between the recesses 4, 5 and one end 11 of the pan. In the illustration of FIG. 1a the cross bar 9 is positioned adjacent end 11; however, if the bracket 6 is folded inward, the cross bar 9 lies above the recesses 4, 5 (see FIG. 3a).

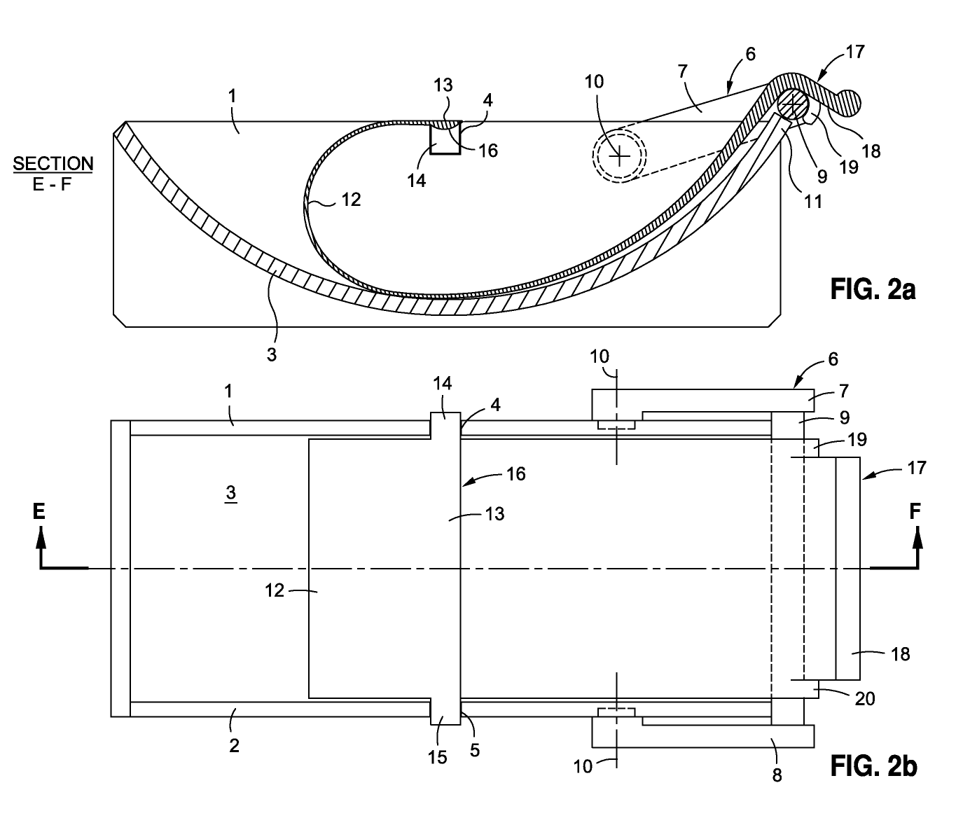

On the bottom 3 of the tub is a band 12, which is preferably slightly longer than the bottom 3, but just as wide. At one end of the band 12 is a web 13 formed across the width of the band 12. The lateral ends of the web 13 define ears 14, 15 configured to fit into the recesses 4, 5 (see FIG. 2a, 2b) and also form a sharp edge of the web stripping 16 at the end of the band 12.

The other end of the band 12 forms a handle 17 by a vertical band 12 projecting to form handle 18, which is integral with the band 12 but preferably has a greater thickness than the latter. On both sides of the handle 18 there are hooks 19, 20, also integral with the band 12 and configured to engage with the cross bar 9.

The device is used as follows: the starting point is the configuration shown in FIGS. 1a, 1b. Food (not shown) is spread on the band 12. To form a sushi roll, a suitable tailored seaweed sheet may be placed on the band 12. The next step is shown in accordance with FIGS. 2a, 2b, with the ears 14, 15 being inserted into the recesses 4, 5, whereby the web 13 is subsequently inserted into the cheeks 1, 2.

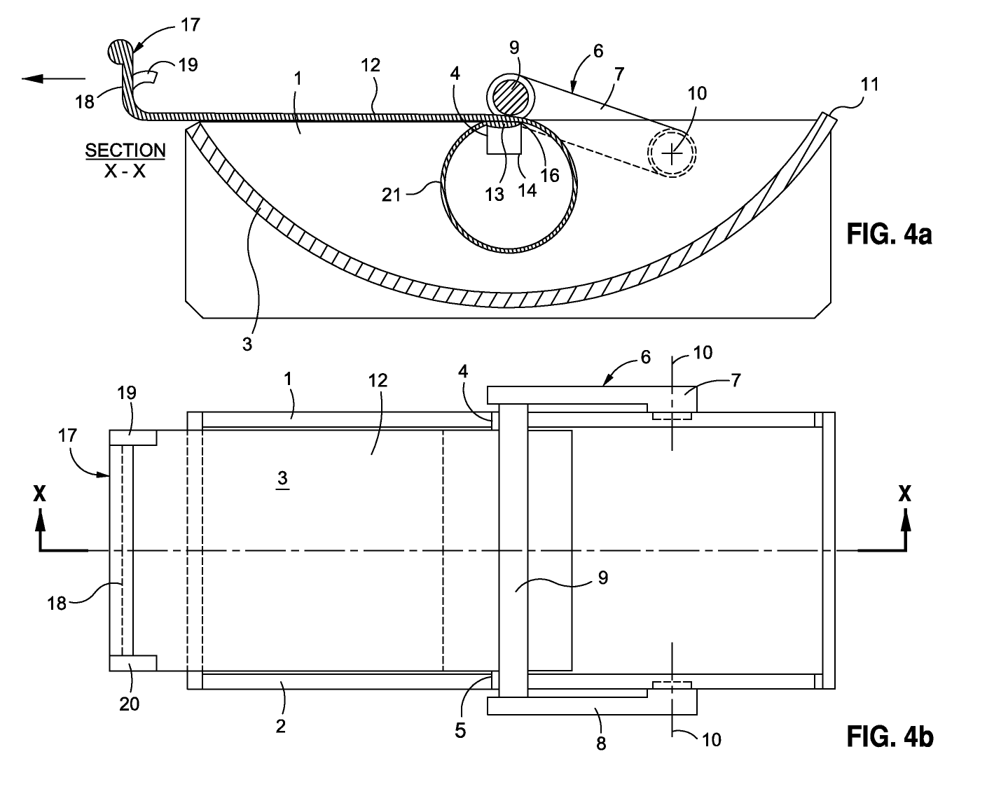

Referring now to FIGS. 3a and 4a, the cross bar 9 is moved to an overlapping position relative to the web 13, so that by a further depression of the bracket 6, the handle 17 is pushed to the subsequent end portion of the band 12 toward the web 13. Thus, the band 12 forms a closed tube 21 around the material to be molded. According to FIG. 4a, 4b, the band 12 is drawn by exerting a pulling force on the handle 17, whereby the tube closes 21 more and more. Pressure is applied to the handle 6 to maintain the tube 21 in a closed configuration. The cheeks 1, 2 prevent the material to be formed from exiting the side of the tube 21. Once the band 12 has been completely moved together so that the cross-section of the tube 21 is filled with the material to be formed, the handle 17 and the handle 6 is released, so that the belt 12 because of its elasticity, will bounce back into a position shown in FIGS. 2a, 2b. This makes it possible to remove the mass shaped by the device.

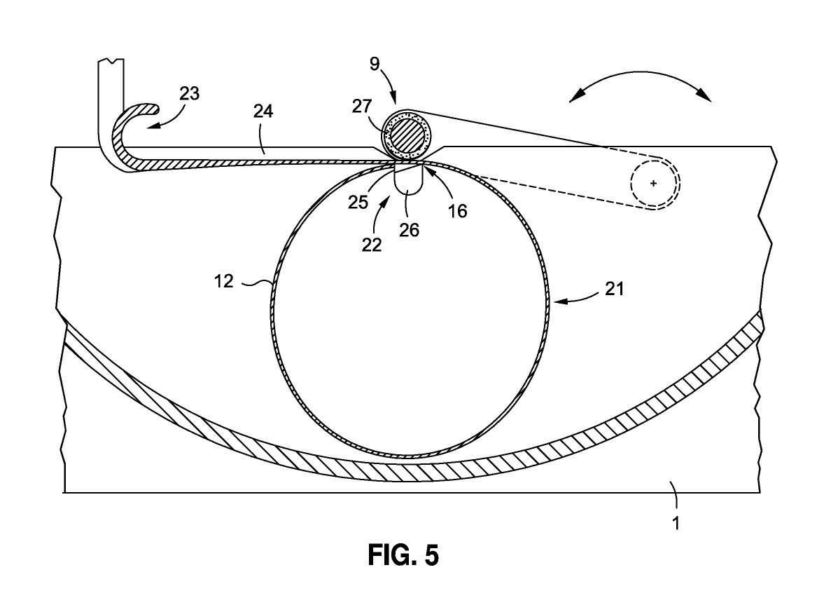

FIG. 5 shows a detailed representation of the definable end 22 of the band 12 and its function. The recesses 26 of the cheeks 1, 2 and the definable end 22 of the band 12 has two special features: In order to prevent parts of the material to be shaped from escaping the tube as the tube is being closed, that is by pulling the free end 23 of the band 12, the end 22 of the band 22 has a sharp scraping edge 12 at 16. This ensures that parts of the food at the “seam” of the tube withdraw without jamming and glide past. The stop edge 25 prevents the edge of the food base (such as an edge of a nori sheet, as used in the manufacture of sushi rolls) from slipping and entering the food material to be shaped, especially during the closure of the “seam” of the tube. The cross bar is—as indicated by the double arrow in FIG. 5—with the help of levers, pivotally attached to the cheeks 1, 2. The upper edges of cheeks 1, 2 are pulled up so far that they act as a lateral guide device 24, by defining a pulling direction for the free end of the strip.

1-29. (canceled)

30. A device for molding food material into a cylindrical roll, the device comprising a flexible band having a free end, a fixable end, an inner side to which the food material to be shaped can be placed, and an opposing outer side, the hand being configured to enable the inner side of the free end to he laid on the outer side of the fixable end to form a tube.

31. The device of claim 30, wherein the cross-section of the tube may be reduced by pulling on the free end of the band.

32. The device of claim 30, wherein the cross-section of the tube may be reduced by pulling on the free end of the band in the direction tangential to the tube.

33. The device of claim 30, wherein the band is configured to form the food on the inside of the tube.

34. The device of claim 30, further comprising a frame including two parallel walls disposed on opposed sides of the band.

35. The device of claim 34, wherein the spacing between the walls is the equal to the width of the band.

36. The device of claim 30, further comprising a frame having an arcuate floor on which the band can be placed.

37. The device of claim 36, characterized in that the frame includes a guide device engageable with the free end of the band, the guide device being configured to move the free end of the band when engaged therewith.

38. The device of claim 37, wherein the frame includes a pair of opposed walls, the guide device being coupled to the pair of opposed walls.

39. The device of claim 30, characterized in that the free end of the belt includes a user definable set bar.

40. The device of claim 39, further comprising a web coupled to the band.

41. The device of claim 40, further comprising a frame having a pair of opposed walls, the web being engageable with the pair of opposed walls to assume a fixed state, wherein the web extends between the walls.

42. The device of claim 41, characterized in that the upper edge of each wall includes a recess configured to receive the lateral ends of the web.

43. The device of claim 40, wherein one of the fixable end of the band and the web has a sharp scraping edge.

44. The device of claim 30, characterized in that the apparatus comprises a cross bar engageable with the fixed end of the hand.

45. The device of claim 44, further comprising a frame having a pair of opposed walls, the cross bar being pivotally mounted to the walls.

46. The device of claim 45, further comprising a lever pivotally mourned to at least one of the pair of opposed walls, the cross bar being mounted to the lever.

47. The device of claim 45, further comprising a pair of levers pivotally mounted to respective ones of the pair of opposed walls, the cross bar being mounted to the pair of levers.

48. The device of claim 30, further comprising a frame, the free end of the band including a handle configured to be releasably engageable with the frame.

49. The device of claim 48, wherein the handle and the belt are formed of one piece.
